(19) United States
(12) Patent Application Publication
(10) Pub. No.: US 2003/0178751 A1
(43) Pub. Date: Sep. 25, 2003

(54) Tin oxide powder, method for preparing the same, and method for manufacturing high-density indium tin oxide target

(76) Inventors: Kyong-hwa Song, Yongin-city (KR); Sang-cheol Park, Seoul (KR); Jung-gyu Nam, Suwon-city (KR)

Correspondence Address: LEE & STERBA, P.C., Suite 2000, 1101 Wilson Boulevard, Arlington, VA, 22209, US

(21) Appl. No.: 10/320,408

(22) Filed: Dec. 17, 2002

(30) Foreign Application Priority Data
Mar. 22, 2002 (KR) 2002-15609

(51) Int. Cl. C04B 33/32

(52) U.S. Cl. 264/603

(57) ABSTRACT

SnO₂ powder having a surface area of about 4-15 m²/g and an average particle diameter of about 50-200 nm, a method for preparing the SnO₂ powder, and a method for making an ITO (indium tin oxide) target. The SnO₂ powder is applicable in forming a high-density indium tin oxide target for a high-quality, transparent electrode for a display, such as a liquid crystal display, electroluminescent display, or field emission display.

### BACKGROUND OF THE INVENTION

1. Field of the Invention

The present invention relates to tin oxide (SnO₂) powder, a method for preparing the tin oxide powder, and a method for manufacturing an indium tin oxide (ITO) target. More particularly, the present invention relates to tin oxide powder for a high-density ITO target which is used in vacuum deposition of a high-quality transparent electrode layer of a display such as a liquid crystal display (LCD), electroluminescent (EL) display, and field emission display (FED), a method for preparing the tin oxide powder, and a method for manufacturing a high-density indium tin oxide target (ITO) using the tin oxide powder.

2. Background of the Invention

Due to their conductivity and transparency with respect to visible light, ITO films with the composition of In₂O₃ and SnO₂ in a ratio of about 9:1 have been widely used as a transparent electrode film for an LCD, EL, or FED. In general, such an ITO film is coated on an insulating substrate such as a glass substrate by sputtering an ITO target. The ITO target is manufactured by molding ITO powder into a predetermined shape, for example, a rectangular parallelepiped shape, followed by sintering at a high temperature. To form a high-quality ITO film on the substrate by sputtering, the ITO target should have a high sintering density. If a low-density ITO target is used to form an ITO film by sputtering, nodules are easily generated on the target surface, thereby lowering the quality and yield of the resulting ITO film.

For this reason, a high-density ITO target is required to form a high-quality, transparent ITO electrode. To form such a high-density ITO target, ITO particles should be of an appropriate primary particle size. If the primary particle size of the ITO particles is too small, grinding the particles after hydroxide calcination is difficult, even though the driving force for sintering increases sufficiently for higher sintering density due to an increased specific surface area. It is also difficult to obtain a large molded body due to stress caused from the generation of many fine pores between the particles during target molding. In contrast, if the primary particle size of the ITO particles is too large, the fluidity and molding properties of the powder are improved, but the driving force for particle sintering is too low, and pores between the particles become greatly enlarged, thereby increasing the energy requirement for removing the pores. For these reasons, to manufacture a high-density ITO target, the particle size should be fine and within a narrow range, and grinding the particles into secondary particles should be easy.

A vapor phase method known for fine powder synthesis currently attracts attention as a method for nano-sized powder synthesis, but is limited to small-scale production of specific powder due to the difficulty of large-scale production. In this method, after powder synthesis, the particle size is reduced by grinding. In other words, the particle size of secondary particles rather than primary particles, which agglomerate to form the secondary particles, is controlled.

A liquid phase method has been used as a general method of large-scale powder production. Among other liquid phase methods, a precipitation method has been especially widely used to prepare ITO powder by precipitating metallic ions in a solution using a precipitant. However, there is a need for an SnO₂ powder synthesis method for an ITO target.

### SUMMARY OF THE INVENTION

It is a feature of an embodiment of the present invention to provide tin oxide (SnO₂) powder for a high-density indium tin oxide (ITO) target and a method for preparing the tin oxide powder.

It is another feature of an embodiment of the present invention to provide a method for manufacturing a high-density ITO target having a sintering density approximate to a theoretical level using the above-prepared tin oxide powder.

In order to provide the above features, an embodiment of the present invention provides SnO₂ powder having a surface area of about 4-15 m²/g and an average particle diameter of about 50-200 nm.

Another embodiment of the present invention provides a method for preparing SnO₂ powder, comprising: preparing a tin solution containing tin ions in a concentration of about 0.5-2 M by dissolving metallic tin in an acid; separating a Sn(OH)ₓ precipitate from the tin solution; and calcining the separated Sn(OH)ₓ precipitate at a temperature of about 400-900° C. to obtain the SnO₂ powder. The acid may include a concentrated nitric acid and a concentrated sulfuric acid. In the structural formula Sn(OH)ₓ of the precipitate, x is 4. The SnO₂ powder preparation method may further comprise washing and drying the precipitate before the calcinations.

Another embodiment of the present invention provides another method for preparing SnO₂ powder, comprising: preparing a tin solution containing tin ions in a concentration of about 0.2-5 M by dissolving a tin-containing salt in water; precipitating a precipitate of Sn(OH)ₓ by adding an alkaline precipitant to the tin solution at a rate of 0.5-3 L/min and adjusting the pH to 7, and separating the precipitate from the tin solution; and then calcining the separated precipitate at a temperature of about 400-900° C. to obtain the SnO₂ powder.

In the method for preparing the SnO₂ powder in this embodiment of the present invention, the tin-containing salt may be selected from the group consisting of SnF₄, SnCl₄, Snl₄, Sn(C₂H₃O₂)₂, SnCl₂, SnBr₂, Snl₂, and a mixture including at least two of the forgoing salts. The alkaline precipitant preferably includes NH₄OH, NH₃ gas, NaOH, KOH, NH₄HCO₃, (NH₄)₂CO₃, and a mixture including at least two of the forgoing salts. The SnO₂ powder method may further comprise washing and drying the precipitate before the calcination, as in the method described above.

In another embodiment of the present invention, a method for manufacturing an ITO (indium tin oxide) target is provided, the method comprising: molding a mixture of about 5-20% by weight SnO₂ powder having a surface area of about 4-15 m²/g and an average particle diameter of about 50-200 nm and about 80-95% by weight In₂O₃ powder; and sintering the molded mixture. In the ITO target manufacturing method, a sintering temperature for the ITO target is preferably from about 1,200° C. to about 1,600° C. The In₂O₃ powder preferably has a surface area of about 5-18 m²/g, and the ITO target has a sintering density of about 7.0-7.15 g/cm³.

With the ITO target according to the present invention, a high-quality transparent electrode for a display such as a liquid crystal display (LCD), electroluminescent display (EL), or field emission display (FED), may be easily manufactured.

### BRIEF DESCRIPTION OF THE DRAWINGS

These and other features and advantages of the present invention will become more apparent by describing in detail exemplary embodiments thereof with reference to the attached drawings in which:

FIG. 1 depicts a flowchart for illustrating first and second embodiments of a method for preparing tin oxide (SnO₂) powder according to the present invention; and

FIG. 2 depicts a flowchart for illustrating a method for manufacturing an indium tin oxide (ITO) target by mixing In₂O₃ powder with the SnO₂ powder prepared by the method according to an embodiment of the present invention.

### DETAILED DESCRIPTION OF THE INVENTION

Tin oxide (SnO₂) powder, a method for preparing the SnO₂ powder, and a method for manufacturing an indium tin oxide (ITO) target using the SnO₂ powder according to the present invention will now be described in detail.

In preparing fine, uniform, highly pure SnO₂ powder, the tin ion concentration of the tin solution is considered to be an important factor for the following reason. According to the mechanism of particle formation by a precipitation method, precipitate nuclei are generated in a reaction solution with the addition of a precipitant. Precipitate nuclei collide and grow into primary particles. These primary particles generate nano-sized powder. In view of the precipitation mechanism, the solution concentration affects the number of precipitate nuclei during the precipitation and the probability of the nuclei colliding, and thus determines the size and shape of the particles. In particular, in a high-concentration reaction solution, precipitate nuclei are more likely to collide so that larger particles than those obtained by using a low-concentration reaction solution may be formed. Due to irregular collisions of particles, particles of a variety of shapes are precipitated. Spherical particles are favourable to increase the density of a sintered ITO body. In this respect, concentration is regarded as one of the most important factors in preparing SnO₂ powder. When SnO₂ powder is formed with the addition of a precipitant to a tin solution, particle shape and size are determined according to the initial concentration of tin. In one embodiment of the present invention, spherical SnO₂ particles of a particular size and surface area, capable of being sintered into a high-density ITO target, are prepared by adjusting the initial concentration of tin ions in a tin solution. Comparing with a conventional method in which SnO₂ synthesis is followed by particle size control using a jet mill, the method for preparing SnO₂ powder according to the present invention is advantageous in that the SnO₂ powder of a particular average particle diameter and surface area for a high-density ITO target may be directly and conveniently synthesized.

The present invention also provides a method for manufacturing a high-density ITO target by limiting the average particle diameter of In₂O₃ powder to provide a maximum sintering density when mixed with the SnO₂ powder of a particular diameter and surface area.

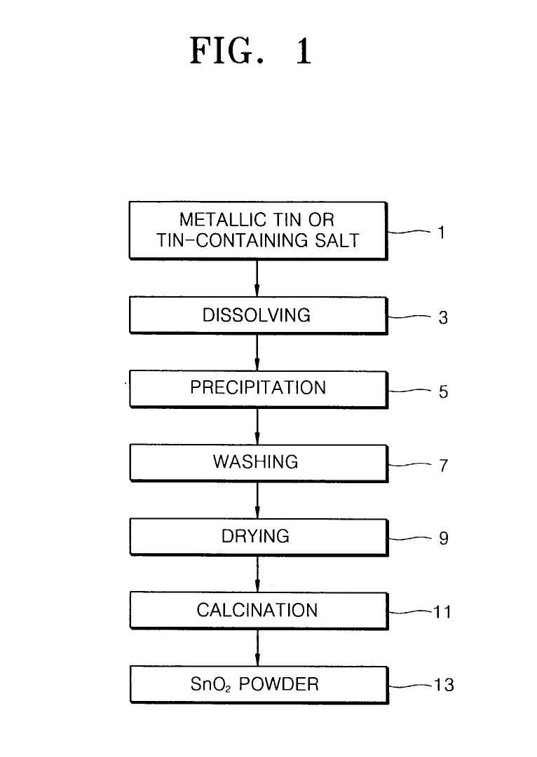

FIG. 1 depicts a flowchart for illustrating first and second embodiments of a method for preparing SnO₂ powder according to the present invention. A first embodiment of the SnO₂ powder preparation method will be described first. Metallic tin is used as a source material (Step 1). Metallic tin is dissolved in an acid, such as a concentrated nitric acid or a concentrated sulfuric acid, to obtain an Sn(OH)₄ precipitate (Step 3). SnO₂ powder of a desired size and surface area is obtained by adjusting the concentration of tin ions in the tin solution to about 0.5-2 M. If the concentration of the tin ions is less than about 0.5 M, precipitation reaction efficiency is poor. If the concentration of the tin ions is greater than about 2 M, non-uniform particles are produced due to thickening of the precipitate slurry during precipitation.

Next, the precipitate is aged, separated by centrifugation, and washed (Step 7). The washed precipitate is dried in an oven (Step 9), ground, and calcined in an electric furnace (Step 11) to obtain SnO₂ powder (Step 13). The calcination temperature is adjusted to about 400-900° C. If the calcination temperature is lower than about 400° C., the average particle diameter of the SnO₂ powder is too small. If the calcination temperature is higher than about 900° C., the SnO₂ powder is sintered.

Hereinafter, a second embodiment of the method for preparing SnO₂ powder according to the present invention will be described with reference to FIG. 1. A tin-containing salt, instead of metallic tin, is used as a source material (Step 1). Any tin-containing salt soluble or decomposable in water, including SnF₄, SnCl₄, Snl₄, Sn(C₂H₃O₂)₂, SnCl₂, SnBr₂, Snl₂, and a mixture including at least two of the foregoing salts, may be used as a material for SnO₂ powder. In the second embodiment, an aqueous tin solution of the tin-containing salt in distilled water is used (Step 3). The initial concentration of tin ions is adjusted to about 0.5-2 M. Next, an alkaline precipitant is added to the aqueous tin solution to obtain Sn(OH)ₓ precipitate (Step 5). The pH of the aqueous tin solution is adjusted to about 3-7 for the Sn(OH)ₓ precipitate. If the pH of the aqueous tin solution is less than 3, the precipitate particles are very small. If the pH of the aqueous tin solution is greater than 7, an adverse effect on the environment due to excess hydroxyl (OH) groups may occur. As described above, no precipitant is necessary to obtain the precipitate in the first embodiment of the SnO₂ preparation method, whereas an alkaline precipitant is necessary to obtain the precipitate in the second embodiment. Types of available alkaline precipitants are not limited. For example, NH₄OH, NH₃ gas, NaOH, KOH, NH₄HCO₃, (NH₄)₂CO₃, and a mixture including at least two of these salts may be used as the alkaline precipitant. The rate of adding the precipitant is adjusted to about 0.5-3 L/min. If the rate of adding the precipitant is less than about 0.5 L/min, precipitation reaction time is increased. If the rate of adding the precipitant is greater than about 3 L/min, the precipitant is not mixed thoroughly, causing partial precipitation, thereby resulting in non-uniform precipitate particles. The following processes, including aging, separation, washing (Step 7), drying (Step 9), and calcination (Step 11) of the precipitant, to obtain the SnO₂ powder (Step 13), are the same as those performed in the first embodiment described above.

With the SnO₂ powder preparation method according to the first or second embodiment of the present invention, it is possible to conveniently prepare SnO₂ powder having a surface area of about 4-15 m₂/g and an average particle diameter of about 50-200 nm when measured by a BET method. If a surface area of the SnO₂ powder measured by the BET method is less than about 4 m²/g (corresponding to an average particle diameter of 200 nm), the primary average particle diameter is too large to provide enough driving force for a high sintering density. If a surface area of the SnO₂ powder is larger than about 15 m²/g (corresponding to an average particle diameter of 50 nm), the primary average particle diameter is too fine to mold the SnO₂ powder. Accordingly, it is difficult to achieve and obtain both a high molding density and high sintering density.

Hereinafter, a method for manufacturing a high-density ITO target using the SnO₂ powder prepared as described above by the method according to the present invention, which has a surface area of about 4-15 m²/g and an average particle diameter of about 50-200 nm when measured by the BET method, will be described.

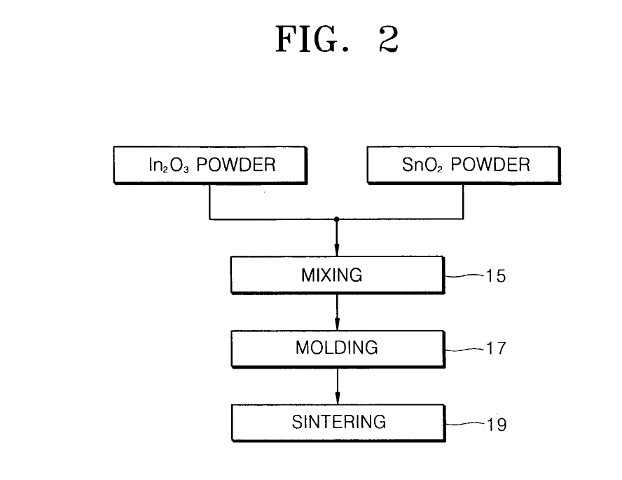

FIG. 2 depicts a flowchart for illustrating a method for preparing a high-density ITO target by mixing In₂O₃ powder with the SnO₂ powder prepared according to the first or second embodiment of the present invention. In this embodiment, 5-20% by weight of the SnO₂ powder prepared according to the first or second embodiment of the present invention and 80-95% by weight of In₂O₃ powder are mixed. The In₂O₃ powder has a surface area of about 5-30 m²/g, preferably 5-18 m²/g, when measured by the BET method. The SnO₂ and the In₂O₃ are mixed by, for example, ball milling (Step 15). The resulting powder mixture is dried and molded into a rectangular parallelepiped target (Step 17). The molded product is thermally treated at about 1,200-1,600° C. in a sintering furnace to obtain an ITO target (Step 19). The characteristics of the final ITO target are evaluated by measuring, for example, the sintering density. If the sintering temperature is lower, than about 1,200° C., it is difficult to completely solidify the two oxides during the sintering, and the energy is insufficient to obtain a high sintering density. If the sintering temperature is above about 1,600° C., which is high enough for phase change and sintering of the oxides, the yield of the ITO target decreases with increasing sintering duration because In₂O₃ and SnO₂ are volatile at high temperatures.

The method for preparing SnO₂ powder and the method for manufacturing an ITO target according to the present invention will be described in detail with reference to the following examples. The following examples are for illustrative purposes and are not intended to limit the scope of the invention.

Synthesis of In₂O₃

A method for synthesizing In₂O₃ powder to be mixed with SnO₂ powder and sintered to form ITO targets in the following examples 1 through 3 and comparative examples 1 and 2 is described herein. A predetermined amount of In(NO₃)₃, equivalent to a final indium ion concentration of 2.5 M, was dissolved in distilled water. A precipitate was obtained by adding 28% NH₄OH as a precipitant to the solution at a rate of 2 L/min. For this precipitation reaction, the pH of the solution was adjusted to 8. The resulting precipitate was aged for 18-24 hours, separated using a centrifuge, and washed. The washed precipitate was dried at 100° C. in an oven, and the dried powder was ground. The ground powder was calcined in an electric furnace at 700° C. for 2 hours. The resulting In₂O₃ powder had a surface area of 18 m²/g when measured by the BET method.

### EXAMPLE 1

In Example 1,300 g metallic tin was placed in a 5-L-beaker. The metallic tin was dissolved by adding 1.5L 60%-nitric acid into the beaker, while stirring, at room temperature. The resulting mixture had a tin ion concentration of 1.0 M. The Sn(OH)ₓ precipitate was aged for 20-24 hours, separated using a centrifuge, and washed with distilled water. The precipitate was dried at 100° C. in an oven, ground, and calcined in an electric furnace at 600° C. for 2 hours to produce SnO₂ powder. The resulting SnO₂ powder had a surface area of 14 m²/g when measured by the BET method.

In₂O₃ powder having a surface area of 18 m²/g when measured by the BET method and the SnO₂ powder prepared as described above were mixed in a weight ratio of 90:10. The powder mixture was molded using a rectangular parallelepiped mold and sintered at 1,500° C. The resulting ITO target of a 20-cm width, 15-cm length, and 1-cm height had a sintering density of 7.13 g/cm³.

### EXAMPLE 2

A predetermined amount of SnCl₄, equivalent to a final tin ion concentration of 1.0 M, was dissolved in distilled water. A precipitate was obtained by adding 28% NH₄OH as a precipitant to the solution at a rate of 1 L/min. The pH of the solution was adjusted to 7. The resulting precipitate was aged for 18-24 hours, separated using a centrifuge, and washed. The washed precipitate was dried at 100° C. in an oven, and the dried powder was ground. The ground powder was calcined in an electric furnace at 700° C. for 2 hours. The resulting SnO₂ powder had a surface area of 12 m²/g when measured by the BET method.

In₂O₃ powder having a surface area of 18 m²/g when measured by the BET method and the SnO₂ powder prepared as described above were mixed in a weight ratio of 90:10. The powder mixture was molded using a rectangular parallelepiped mold and sintered at 1,500° C. The resulting ITO target of a 20-cm width, 15-cm length, and 1-cm height had a sintering density of 7.14 g/cm³.

### EXAMPLE 3

A predetermined amount of SnCl₄, equivalent to a final tin ion concentration of 1.5 M, was dissolved in distilled water. A precipitate was obtained by adding 28% NH₄OH as a precipitant to the solution at a rate of 2 L/min. The pH of the solution was adjusted to 7. The resulting precipitate was aged for 18-24 hours, separated using a centrifuge, and washed. The washed precipitate was dried at 100° C. in an oven, and the dried powder was ground using a hammer mill. The ground powder was calcined in an electric furnace at 600° C. for 2 hours. The resulting SnO₂ powder had a surface area of 13 m²/g when measured by the BET method.

In₂O₃ powder having a surface area of 18 m²/g when measured by the BET method and the SnO₂ powder prepared as described above were mixed in a weight ratio of 90:10. The powder mixture was molded using a rectangular parallelepiped mold and sintered at 1,550° C. The resulting ITO target of a 20-cm width, 15-cm length, and 1-cm height had a sintering density of 7.12 g/cm³.

### Comparative Example 1

A predetermined amount of SnCl₄, equivalent to a final tin ion concentration of 0.3 M, was dissolved in distilled water. A precipitate was obtained by adding 28% NH₄OH as a precipitant to the solution at a rate of 1 L/min. The pH of the solution was adjusted to 7. The resulting precipitate was aged for 18-24 hours, separated using a centrifuge, and washed. The washed precipitate was dried at 100° C. in an oven, and the dried powder was ground using a hammer mill. The ground powder was calcined in an electric furnace at 600° C. for 2 hours. The resulting SnO₂ powder had a surface area of 16 m²/g when measured by the BET method.

In₂O₃ powder having a surface area of 18 m²/g when measured by the BET method and the SnO₂ powder prepared as described above were mixed in a weight ratio of 90:10. The powder mixture was molded using a rectangular parallelepiped mold and sintered at 1,550° C. The resulting ITO target of a 20-cm width, 15-cm length, and 1-cm height had a sintering density of 6.58 g/cm³.

### Comparative Example 2

A predetermined amount of SnCl₄, equivalent to a final tin ion concentration of 3.0 M, was dissolved in distilled water. A precipitate was obtained by adding 28% NH₄OH as a precipitant to the solution at a rate of 1 L/min. The pH of the solution was adjusted to 7. The resulting precipitate was aged for 18-24 hours, separated using a centrifuge, and washed. The washed precipitate was dried at 100° C. in an oven, and the dried powder was ground using a hammer mill. The ground powder was calcined in an electric furnace at 600° C. for 2 hours. The resulting SnO₂ powder had a surface area of 3 m²/g when measured by the BET method.

In₂O₃ powder having a surface area of 18 m²/g when measured by the BET method and the SnO₂ powder prepared as described above were mixed in a weight ratio of 90:10. The powder mixture was molded using a rectangular parallelepiped mold and sintered at 1,550° C. The resulting ITO target of a 20-cm width, 15-cm length, and 1-cm height had a sintering density of 6.35 g/cm³.

The main SnO₂ powder preparation conditions and the sintering density of each of the ITO targets in examples 1 through 3 and comparative examples 1 and 2 are tabled in Table 1.

TABLE 1

| | | | | | | | | Sintering |
|---|---|---|---|---|---|---|---|---|
| | Tin | Rate of | | | Surface | Surface | Particle | Density |
| | Concen- | Precipitant | | Calcination | Area of | Area of | Diameter | of ITO |
| | tration | Addition | Reaction | Temperature | In₂O₃ | SnO₂ | of SnO₂ | target |
| Example | (M) | (L/min) | pH | (° C.) | (m²/g) | (m2/g) | (nm) | (g/cm³) |
| Example 1 | 1.0 | — | — | 600 | 18 | 14 | 62 | 7.13 |
| Example 2 | 1.0 | 1 | 7 | 700 | 18 | 12 | 72 | 7.14 |
| Example 3 | 1.5 | 2 | 7 | 600 | 18 | 13 | 66 | 7.12 |
| Comparative | 0.3 | 1 | 7 | 600 | 18 | 16 | 54 | 6.58 |
| Example 1 | | | | | | | | |
| Comparative | 3.0 | 1 | 7 | 600 | 18 | 3 | 287 | 6.35 |
| Example 2 | | | | | | | | |

According to the present invention, SnO₂ powder is prepared by adjusting the concentration of tin ions as well as the rate of adding the precipitant, the pH of the tin solution, and the calcination temperature, and sintering the mixture. As is apparent from Table 1, by mixing In₂O₃ powder with the SnO₂ powder prepared according to the present invention, a high-density ITO target of 7.12-7.14 g/cm³, which approximates to a theoretical density of 7.15 g/cm³, is obtained.

According to the SnO₂ powder preparation method of the present invention, it is possible to conveniently manufacture SnO₂ powder having a uniform primary average particle diameter of 50-200 nm, which may then be further ground into secondary particles of a size (D50 or D90) less than 10 μm. Through sintering after mixing In₂O₃ powder of a uniform average particle diameter with the SnO₂ powder prepared by the method according to the present invention, a high-density ITO target may be manufactured. The high-density ITO target according to the present invention is applicable in forming a high-quality, transparent electrode film for a LCD, EL, FED, etc. by sputtering in a vacuum.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. SnO₂ powder having a surface area of about 4-15 m²/g and an average particle diameter of about 50-200 nm.

2. A method for preparing SnO₂ powder, comprising:
preparing a tin solution containing tin ions in a concentration of about 0.5-2 M by dissolving metallic tin in an acid;
separating a Sn(OH)ₓ precipitate from the tin solution; and
calcining the separated Sn(OH)ₓ precipitate at a temperature of about 400-900° C. to obtain the SnO₂ powder.

3. The method as claimed in claim 2, wherein the acid includes a concentrated nitric acid and a concentrated sulfuric acid.

4. The method as claimed in claim 2, wherein, in the structural formula Sn(OH)ₓ of the precipitate, x is 4.

5. The method as claimed in claim 2, further comprising washing and drying the precipitate before the calcinations.

6. A method for preparing SnO₂ powder, comprising:
preparing a tin solution containing tin ions in a concentration of about 0.2-5 M by dissolving a tin-containing salt in water;
precipitating a precipitate of Sn(OH)ₓ by adding an alkaline precipitant to the tin solution at a rate of 0.5-3 L/min and adjusting the pH to 7, and separating the precipitate from the tin solution; and
calcining the separated precipitate at a temperature of about 400-900° C. to obtain the SnO₂ powder.

7. The method as claimed in claim 6, wherein the tin-containing salt is selected from the group consisting of SnF₄, SnCl₄, Snl₄, Sn(C₂H₃O₂)₂, SnCl₂, SnBr₂, Snl₂, and a mixture including at least two of the forgoing salts.

8. The method as claimed in claim 6, wherein the alkaline precipitant includes NH₄OH, NH₃ gas, NaOH, KOH, NH₄HCO₃, (NH₄)₂CO₃, and a mixture including at least two of the foregoing salts.

9. The method as claimed in claim 6, further comprising washing and drying the precipitate before calcining the precipitate.

10. A method for manufacturing an ITO (indium tin oxide) target, comprising:
molding a mixture of about 5-20% by weight SnO₂ powder having a surface area of about 4-15 m²/g and an average particle diameter of about 50-200 nm and about 80-95% by weight In₂O₃ powder; and
sintering the molded mixture.

11. The method as claimed in claim 10, wherein the ITO target has a sintering density of about 7.0-7.15 g/cm³.

12. The method as claimed in claim 10, wherein a sintering temperature for the ITO target is from about 1 ,200° C. to about 1,600° C.

13. The method as claimed in claim 10, wherein the In₂O₃ powder has a surface area of about 5-18 m²/g.
